(19) United States
(12) Patent Application Publication
(10) Pub. No.: US 2005/0133095 A1
(43) Pub. Date: Jun. 23, 2005

(54) Ball check for pressure test port

(76) Inventor: Thomas D. Nogle, Troy, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/744,866

(22) Filed: Dec. 23, 2003

(51) Int. Cl. F16K 15/04

(52) U.S. Cl. 137/533.11

(57) ABSTRACT

A transmission has a housing with interior and an exterior surfaces. A fluid passage is located in the interior of the housing. A ball-check assembly has a ball; a conical retaining chamber with an end with an inner diameter greater than the diameter of the ball, and an end with an inner diameter less than the diameter of the ball; and a conical wall extending between the two ends. The fluid passage is in fluid communication with the ball check assembly. The ball is located in the conical retaining chamber and is dimensioned to become wedged against the conical wall as the ball is moved from the greater diameter end toward the lesser diameter end, thereby providing a seal between the ends of the conical retaining chamber.

### FIELD OF THE INVENTION

This invention relates generally to ball check valves and more particularly to ball check valves wherein the ball is translated to a sealed position by fluid pressure across the ball.

### BACKGROUND

Hydraulic devices, such as automatic transmissions for vehicles, have fluid passages interconnecting various operating elements, such as pistons and valves. It is desirable to provide a test port for connecting fluid test equipment to these passages while the hydraulic equipment is being tested. It is desirable that the test port provides a simple means for fluid connection between a test probe and a fluid passage. It is also desirable that the test port reliably seals air and debris from the fluid passage once testing is complete.

### SUMMARY OF THE INVENTION

Accordingly, an aspect of the present invention is to provide a test port which reliably seals air and debris from a fluid passage and facilitates measuring pressure within the fluid passage.

In accordance with these aspects, a ball-check assembly is provided which has a ball in a conical retaining chamber with an open proximate end having an inner diameter greater than the diameter of the ball and an open distal end having an inner diameter less than the diameter of the ball, and a conical wall extending between the proximate and distal ends. The ball is located in the conical retaining chamber and becomes wedged against the conical wall as the ball is moved from the proximate end toward the distal end. A seal is thereby provided between the open proximate and open distal ends of said conical retaining chamber.

Further areas of applicability of the present invention will become apparent from the detailed description provided hereinafter. It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

FIG. 1 is a cross-section diagram of a prior art ball check; and

FIG. 2 is a cross section diagram of a redesigned ball check.

### DETAILED DESCRIPTION OF THE PREFERRED EMBODIMENT

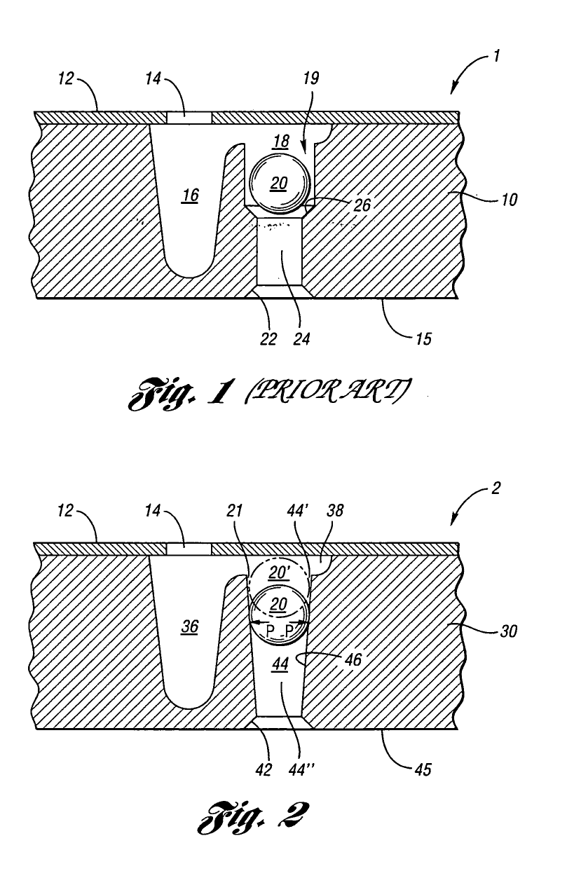

Turning now to FIG. 1, a cross section diagram of a prior-art ball check is shown. A hydraulic device 1 has a housing 10. The housing 10 contains a fluid passage 16 in communication with a test passage 18. The fluid and test passages 16, 18 are covered by a plate 12, which may include a fluid passage 14 for fluid communication with other passages (not shown). The test passage 18 is in fluid communication with a retaining chamber 19, which retains a ball 20. The ball 20 rests upon an annular ball seat 26 to seal test passage 18 from a proximate end of probe passage 24. A conical test probe lead-in 22 is provided at a distal end of probe passage 24. The test probe lead-in 22, test passage 24, annular ball seat 26, and retaining chamber 19 are coaxially aligned along an axis substantially normal to exterior surface plane 15. The exterior surface 15 is generally exposed to the environment.

During a test period, a test probe (not shown) is pressed against the probe lead-in 22. A stylus, which is integral to the probe, protrudes through the probe passage 24 and lifts ball 20 from the annular ball seat 26. The fluid port 16 is thereby in fluid communication with the probe passage 24, and fluid pressure within the passage 16 is measured by the test probe at test passage 24.

The test probe and stylus are withdrawn at the end of the test period, allowing the ball 20 to seat against the annular ball seat 26. The ball is urged against the seat by a difference in fluid pressure between test passage 18 and probe passage 24.

When the difference in fluid pressure is minimal, such as when passage 16 is unpressurized, ball 20 may vibrate and lift from the annular ball seat 26. With the ball 20 lifted, and test passage 18 exposed to the environment, an undesirable opportunity arises for foreign material, such as debris, air, or water, to pass between the ball 20 and annular ball seat 26 and compromising the fluid within fluid passage 16.

Turning to FIG. 2, a hydraulic device 2 having an improved check ball assembly is shown in cross section. A hydraulic device 2 has a housing 30. The housing 30 contains a fluid passage 36 in communication with a test passage 38. The fluid and test passages 36, 38 are covered by a plate 12, which may include a second fluid passage 14 for fluid communication with other passages (not shown). The test passage 38 is in fluid communication with an end 44′ of a conical retaining chamber 44. At end 44′, the conical retaining chamber 44 has a diameter larger than the diameter of ball 20. The ball 20 is located within the conical retaining chamber 20 and restrained therein at the end 44′ by plate 12. At an opposite end 44″ of the conical retaining chamber, the chamber has a diameter less than the diameter of ball 20. The end 44″ of the conical retaining chamber is in fluid communication with a test probe lead-in 42. The test probe lead-in 42 and conical retaining chamber 44 are coaxially aligned along an axis substantially normal to exterior surface plane 45. The exterior surface 45 can be generally exposed to the environment.

During a test, a test probe (not shown) is pressed against the probe lead-in 42. The probe's stylus protrudes through the end 44″ of conical retaining chamber 44 and forces ball 20 towards the end 44′ as illustrated by dashed ball 20′. As the ball 20 traverses to position 20′, a clearance 21 is created between the fixed diameter of ball 20 and the increasing diameter of the proximate end 44′. The clearance 21 places the fluid port 36 in fluid communication with the test probe, and fluid pressure within the passage 36 is effectively measured by the probe.

The test probe and stylus are withdrawn at the end of the test period, thereby allowing the ball 20 to be urged toward end 44″ of conical retaining chamber 44. The ball 20 is urged by a difference in fluid pressure between test passage 38 and end 44″ of conical retaining chamber 44, and resultantly becomes wedged against conical wall 46. The wedged ball 20 is retained in position by a frictional force parallel with the conical wall 46. The frictional force is dependent upon the force P exerted on the conical wall 46 by the wedged ball 20.

When the difference in fluid pressure is minimal, such as when passage 36 is unpressurized, ball 20 remains wedged against the conical wall 46. The wedged ball 20 prevents an undesirable opportunity for foreign material to pass between ball 20 and conical wall 46, thereby compromising the fluid within fluid passage 16. However, the frictional force exhibited on the dedged ball is such that it can be overcome by insertion of a test probe. An angle of the tapered wall 46 with respect to an axial centerline of conical retaining chamber 44 is preferably selected between 3 and 15 degrees. A lower angle improves reliability of the wedging seal; however it also requires greater dimensional control in the diameter of the ball and diameters of the conical retaining chamber. Conversely, a higher angle reduces reliability of the wedging seal; however it also increases the dimensional tolerances of both the ball 20 and the diameters of the conical retaining chamber 44.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A transmission for a vehicle, said transmission comprising:
a housing having an interior and an exterior surface;
a fluid passage located in the interior of said housing;
a ball-check assembly further comprising a ball; a conical retaining chamber having an end with an inner diameter greater than the diameter of said ball, and an end having an: inner diameter less than the diameter of said ball; and a conical wall extending between the two ends, said fluid passage being in fluid communication with said ball check assembly;
wherein said ball is located in said conical retaining chamber and is dimensioned to become wedged against said conical wall as said ball is moved from the greater diameter end toward the lesser diameter end, thereby providing a seal between the ends of said conical retaining chamber.

2. The transmission of claim 1 wherein the angle between said conical wall and the axial centerline of said conical retaining chamber is 15 degrees or less.

3. The transmission of claim 2 wherein the angle between said conical wall and the axial centerline of said conical retaining chamber is 3 degrees or greater.

4. The transmission of claim 1 further comprising a test-probe lead-in in fluid communication with the lesser diameter end of the conical retaining chamber.

5. A method of sealing a fluid-containing passage from environmental debris, said method comprising:
positioning a ball within a conical retaining chamber positioned to be in fluid communication with the fluid-containing passage, the chamber having a larger diameter end and a lesser diameter end,
applying pressure to said ball, thereby forcing said ball towards said lesser diameter end until said ball comes to rest at a wedged position within the chamber;
wherein said ball at said wedged position provides a seal between the fluid containing passage and environmental debris at said distal end of said conical retaining chamber.
